(19) United States
(12) Patent Application Publication
(10) Pub. No.: US 2015/0083812 A1
(43) Pub. Date: Mar. 26, 2015

(54) TEMPERATURE ADJUSTMENT SYSTEM AND METHOD

(71) Applicant: General Electric Company, Schenectady, NY (US)

(72) Inventors: Irena Jozic McDowell, Louisville, KY (US); Michael Thomas Beyerle, Pewee Valley, KY (US); Robert Marten Bultman, Louisville, KY (US); Jay Andrew Broniak, Louisville, KY (US); Joseph Mark Brian, Louisville, KY (US)

(73) Assignee: General Electric Company, Schenectady, NY (US)

(21) Appl. No.: 14/036,007

(22) Filed: Sep. 25, 2013

(51) Int. Cl. G05D 23/19

(52) U.S. Cl. CPC G05D 23/1932
USPC 236/1 C

(57) ABSTRACT

Temperature adjustment systems and methods for adjusting thermostat temperature settings are provided. A system includes an oven appliance sensor in communication with an oven appliance, the oven appliance sensor operable to sense an operation of the oven appliance. The system further includes a thermostat in communication with the oven appliance sensor, the thermostat operable to adjust a temperature setting based on the sensed operation of the oven appliance. A method includes sensing an operation of an oven appliance, communicating the operation of the oven appliance to the thermostat, and adjusting the thermostat temperature setting based on the sensed operation of the oven appliance.

### FIELD OF THE INVENTION

The present subject matter relates generally to systems and methods for adjusting thermostat temperature settings, and more particularly to systems and methods which facilitate such adjustments based on oven appliance operations.

### BACKGROUND OF THE INVENTION

Oven appliances are frequently utilized to in a variety of settings to cook food items. During operation of an oven appliance, and due to the relatively high temperatures generated in the chamber of the oven appliance, the temperature of the area and environment surrounding the oven appliance can experience an increase in temperature. In particular, in residential homes, this increase in temperature can affect for example an entire level of a home, such as an upper level, or the entire home itself. Such temperature increases can be detrimental particularly in the summer, when the air conditioning is typically running to keep home temperatures relatively low. Such temperature increases can also be detrimental in the winter, when the heat is typically running to keep home temperatures relatively higher, due to the possibility of overheating.

In typical homes and other indoor settings, thermostats are utilized to regulate the environmental temperature. Such thermostats typically have a sensor within the thermostat that detects the temperature near the thermostat, and the thermostat may react to this temperature by activating either air conditioning or heat to respectively cool or heat the environment, thus lowering or raising the temperature as required. However, due to these sensors being located in the thermostats, the thermostats do not activate cooling or heating until a certain temperature is detected at sensors, while other locations within an indoor setting may meanwhile be experiencing this temperature. This can be uncomfortable to, for example, residents located in areas away from the thermostats.

Accordingly, improved systems and methods for adjusting temperature settings in thermostats are desired in the art. In particular, systems and methods that adjust such temperature settings based on operation of oven appliances would be advantageous.

### BRIEF DESCRIPTION OF THE INVENTION

In one embodiment, the present disclosure is directed to a temperature adjustment system. The system includes an oven appliance sensor in communication with an oven appliance, the oven appliance sensor operable to sense an operation of the oven appliance. The system further includes a thermostat in communication with the oven appliance sensor, the thermostat operable to adjust a temperature setting based on the sensed operation of the oven appliance.

In another embodiment, the present disclosure is directed to a method for adjusting a thermostat temperature setting. The method includes sensing an operation of an oven appliance, communicating the operation of the oven appliance to the thermostat, and adjusting the thermostat temperature setting based on the sensed operation of the oven appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic of a temperature adjustment system in accordance with one embodiment of the present disclosure;

FIG. 2 is a front, elevation view of an oven appliance in accordance with one embodiment of the present disclosure; and

FIG. 3 is a flow chart illustrating a method in accordance with one embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

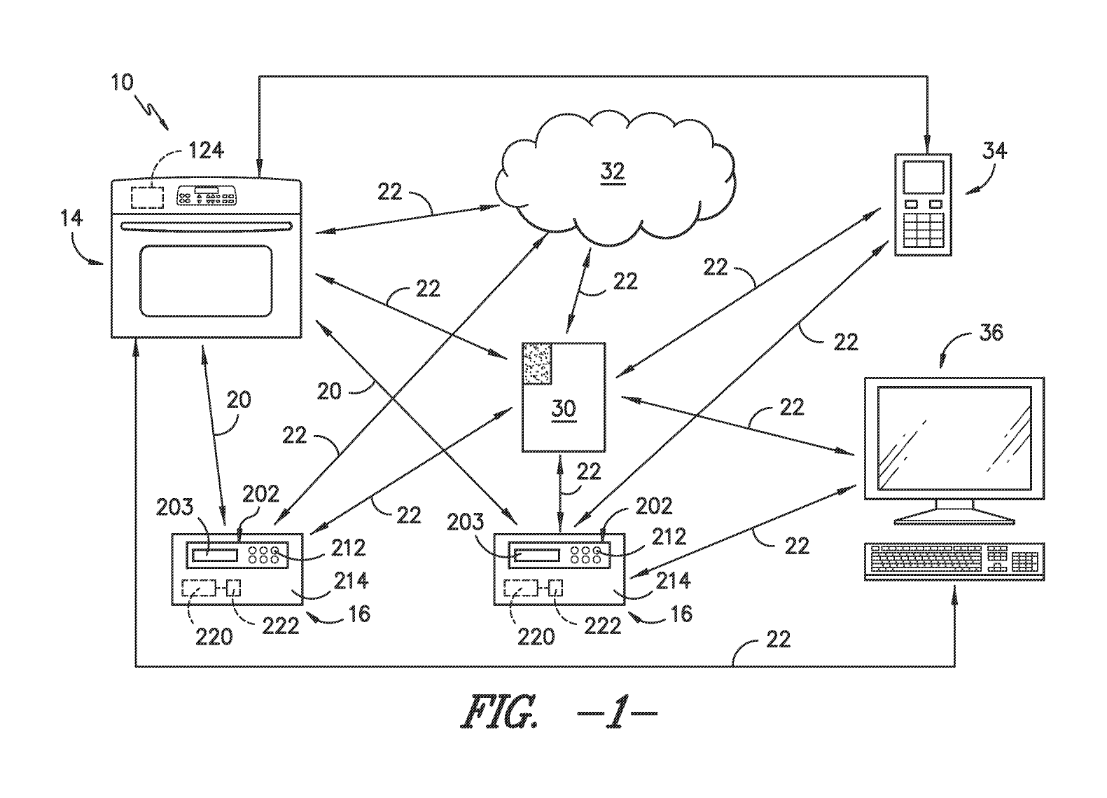

FIG. 1 is a schematic illustration of various components of a temperature adjustment system 10 in accordance with one embodiment of the present disclosure. As shown, a system 10 may include one or more thermostats 16 and an oven appliance 14. In general, the present system 10 facilitates operation of the thermostat 12 based on sensed operations of the oven appliance 14. Thus, when a required operation of the oven appliance 14 is performed, the thermostat 12 may be operated to adjust the thermostat's temperature setting. Such interaction between the oven appliance 14 and thermostat 12 advantageously prevents an indoor setting, such as a home, from becoming overheated due to rising temperatures proximate the oven appliance 14 but distal from the thermostat 12.

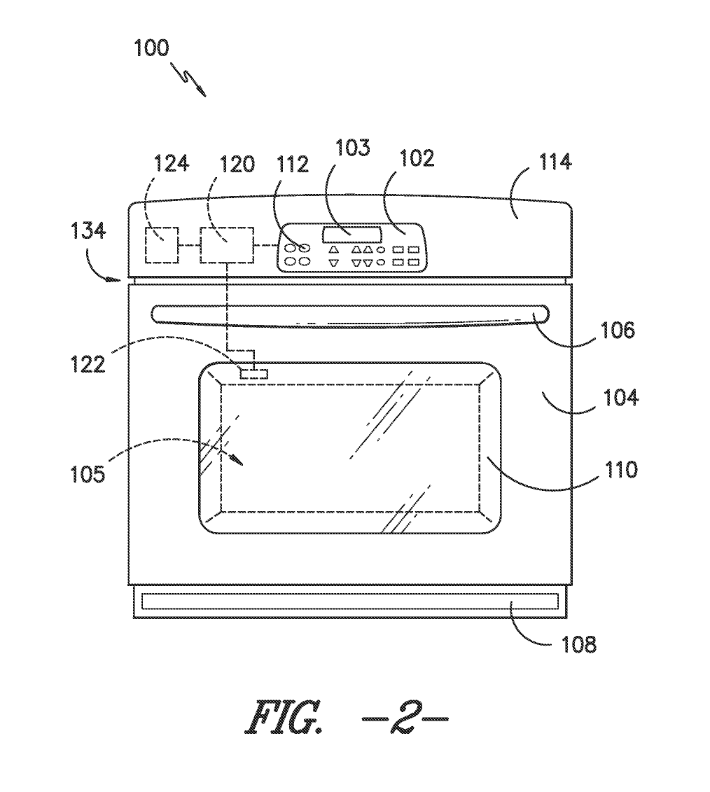

Referring briefly to FIG. 2, a front, elevation view of an oven appliance 14 according to an exemplary embodiment of the present disclosure is provided. Oven appliance 14 includes a door 104 with a handle 106 that provides for opening and closing access to a cooking chamber 105. A user of the oven appliance 14 can place a variety of different items to be cooked in chamber 105. A broil or top heating elements and a bake or bottom heating element are positioned at or adjacent the top of chamber 105 and the bottom of chamber 105, respectively, and provide heat for cooking. Top and bottom heating elements and can be gas burners, electric resistance heating elements, microwave elements, or a combination thereof. Racks (not shown) in chamber 105 can be used to place food items at various levels for cooking. A window 110 on door 104 allows the user to view chamber 105 during the cooking process.

Oven appliance 14 includes a user interface 102 having a display 103 and a variety of controls 112. User interface 102 may be positioned on a top panel 114 of oven appliance 14. User interface 102 allows the user to select various options for the operation of oven appliance 14 including e.g., temperature, time, and/or various cooking and cleaning cycles.

Operation of oven appliance 14 can be regulated by a controller 120 that is operatively coupled or in communication with user interface panel 102, top and bottom heating elements and other components of oven appliance 14. As an example, in response to user manipulation of the user interface panel 102, the controller 120 can operate top and bottom heating elements. The controller 120 can also receive measurements from a temperature sensor 122 within chamber 105 and provide a temperature indication to the user with display 103. Input/output (“I/O”) signals are routed between the controller and various operational components of appliance 14, such as top and bottom heating elements, controls 112, display 103, sensor(s), alarms, and/or other components as may be provided. In one embodiment, the user interface panel 102 may represent a general purpose I/O (“GPIO”) device or functional block.

As will be understood by those skilled in the art, oven appliance 14 is provided by way of example only. Thus, although shown as a single wall oven appliance in the exemplary embodiment of FIG. 2, the present subject matter can also be used with other oven appliances. For example, the present subject matter may be used with double wall oven appliances, oven range appliances, etc.

Referring still to FIG. 2, oven appliance 14 may include an oven appliance sensor 124. Oven appliance sensor 124 may be in communication with the oven appliance 14 and the thermostat 16, and may be operable to sense one or more operations of the oven appliance 14. Various operations may be detected by the sensor 124. For example, in some embodiments, an operation may be activation of the oven appliance 14. Thus, when the oven appliance 14 is turned on or off by, for example, user manipulation of the user interface panel 102, etc., such operation may be sensed by the sensor 124. Alternatively, an operation may be a temperature setting increase. Thus, when the temperature setting of the oven appliance 14 is increased or decreased, such as for example above or below a predetermined temperature setpoint, by, for example, user manipulation of the user interface panel 102, etc., such operation may be sensed by the sensor 124. In further alternative embodiments, an operation may be a cooking mode change, such as from or to bake, broil, or self-clean modes. Thus, when the cooking mode of the oven appliance 14 is changed by, for example, user manipulation of the user interface panel 102, etc., such operation may be sensed by the sensor 124.

It should be understood that while the various operations discussed above are in the context of operation of the chamber 105 of the oven appliance 14, the present disclosure is not limited to such operation. Rather, an oven appliance sensor 124 may be operable to sense an operation of one or more chambers 105, one or more cook-top burners, and/or any other suitable heating component of the oven appliance 14.

It should further be understood that sensor 124 may be in communication with user interface panel 102, temperature sensor 122, and/or controller 120. Further, in some embodiments, sensor 124 may be a component of controller 120. Alternatively, sensor 124 may be separate from controller 120. Such communication may be through a suitable wired or wireless connection, as desired or required.

Referring again to FIG. 1, one or more thermostats 16 may be in communication with the oven appliance sensor 124, through for example a suitable wired or wireless connection. Oven appliance sensor 124 may thus communicate signals associated with sensed operations of the oven appliance 14 to the thermostat 16.

Thermostat 16 may generally be in communication with heating and/or air conditioning unit(s), and may control operation of these units. For example, the units may be activated by the thermostat 16 as required to adjust, for example, a room temperature to a desired temperature setting of the thermostat. Typically, the thermostat can be set in an air conditioning mode, such that an air conditioning unit operates are required, and a heat mode, such that a heating unit operates as required.

Thermostat 16 includes a user interface 202 having a display 203 and a variety of controls 212. User interface 202 may be positioned on a front face 214 of thermostat 16. User interface 102 allows the user to select various options for the operation of thermostat 16, including e.g., temperature, time, and/or various modes, such as heating mode and air conditioning mode.

Operation of thermostat 16 can be regulated by a controller 220 that is operatively coupled or in communication with user interface panel 202, a thermometer or other suitable temperature sensor 222, and other components of thermostat 16. As an example, in response to user manipulation of the user interface panel 202, the controller 220 can operate a heating and/or air conditioning unit as required. The controller 220 can also receive measurements from a temperature sensor 222, and provide a temperature indication to the user with display 203. Input/output (“I/O”) signals are routed between the controller and various operational components of thermostat 16, such as controls 212, display 203, sensor(s), alarms, and/or other components as may be provided. In one embodiment, the user interface panel 202 may represent a general purpose I/O (“GPIO”) device or functional block.

In exemplary embodiments, controller 220 may receive signals from the oven appliance sensor 124 which correspond to sensed operations of the oven appliance 14. Thermostat 16 may further be operable to adjust one or more temperature settings, such as for one or more air conditioning and/or heating units, based on the sensed operations of the oven appliance 14. For example, in some exemplary embodiments, the thermostat 16 may be operable to adjust the temperature setting by a predetermined interval. In these embodiments, when an oven appliance 14 operation is sensed and communicated to the thermostat 16, the controller 220 may lower the current temperature setting by a predetermined amount, such as for example 2 degrees Fahrenheit. In other exemplary embodiments, the thermostat 16 may be operable to adjust the temperature setting to a predetermined setpoint. In these embodiments, when an oven appliance 14 operation is sensed and communicated to the thermostat 16, the controller 220 may lower the current temperature setting to a predetermined temperature, such as for example to 70 degrees Fahrenheit.

It should be understood that any suitable adjustment operation by the thermostat 16 may be performed in the air conditioning mode and/or the heating mode, as desired or required. Various setpoints and set intervals may be utilized for various thermostat 16 modes, such that for example a setpoint and/or set interval for an air conditioning mode is independent from a setpoint and/or set interval for a heating mode. It should further be understood that such setpoint and set intervals may be determined during manufacture of the thermostat 16 and/or input by a user of the thermostat 16.

A change in thermostat 16 temperature setting due to adjustment of the thermostat 16 based on a sensed operation of the oven appliance 14 may remain for either a predetermined period of time or until the sensed operation has ceased. For example, in some embodiments, when an adjustment occurs, the new temperature setting may remain for a predetermined number of minutes, hours, etc. In other embodiments, when an adjustment occurs, the new temperature setting may remain until the sensed operation of the oven appliance 14 has ceased.

As discussed, the thermostat 16 may be in communication with the oven appliance 14 and sensor 124 thereof, such as through a suitable wired or wireless connection. In some exemplary embodiments, the sensor 124 and thermostat 16 may be in direct communication, as indicated in FIG. 1 by reference arrow 20, such that signals are transmitted directly from the sensor 124 to the thermostat 16 through a suitable wired or wireless connection. In other embodiments, the sensor 124 and thermostat 16 may be in direct communication, as indicated in FIG. 1 by reference arrow 22, such that signals are transmitted from the sensor 124 to other system 10 components, and then from those components to the thermostat 16. For example, FIG. 1 further illustrates optional additional components of the system 10, such as a gateway device 30, a cloud storage 32, and various personal electronic devices such as cellular telephone 34 and a computer 36. Each of these components may be in communication with the sensor 124 and thermostat 16, and may provide indirect communication between the sensor 124 and thermostat 16. In some exemplary embodiments, as shown, each component 14, 16, 32, 34, 36 may be in communication with the gateway device 30. A gateway device 30 is generally a central controller for various other components, allowing the components to communicate with each other through the gateway device 30. For example, in some embodiments, a gateway device 30 may be or include a router. Gateway device 30 may communicate with other components through any suitable communication means, including for example, a suitable wireless protocol such as Wi-Fi, Zigbee, etc. Additionally or alternatively, the sensor 124 and thermostat 16 communication may be through another suitable component of the system 10, bypassing the gateway device 30. Such indirect communication through other system 10 components allows communication and control of the system 10 both on location and from remote locations, as desired or required.

It should be understood that a direct or indirect communication between any suitable devices or components as discussed herein may be facilitated through any suitable wired or wireless connection, including suitable wireless protocols such as Wi-Fi, Zigbee, etc.

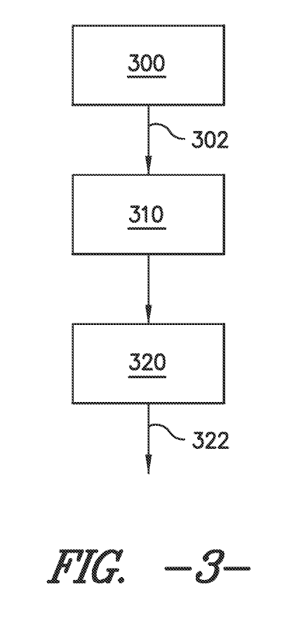

As illustrated in FIG. 3, the present disclosure is further directed to methods for adjusting thermostat 16 temperature settings. A method may include, for example, the step 300 of sensing an operation 302 of an oven appliance 14, as discussed above. A method may further include, for example, the step 310 of communicating the operation 302 of the oven appliance 14 to the thermostat 16, as discussed above. A method may further include, for example, the step 320 of adjusting the thermostat 16 temperature setting 322 based on the sensed operation of 302 of the oven appliance 14, as discussed above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A temperature adjustment system, the system comprising:
an oven appliance sensor in communication with an oven appliance, the oven appliance sensor operable to sense an operation of the oven appliance; and
a thermostat in communication with the oven appliance sensor, the thermostat operable to adjust a temperature setting based on the sensed operation of the oven appliance.

2. The temperature adjustment system of claim 1, wherein the oven appliance sensor is in direct communication with the thermostat.

3. The temperature adjustment system of claim 1, further comprising a gateway device, and wherein the oven appliance sensor is in indirect communication with the thermostat through the gateway device.

4. The temperature adjustment system of claim I, further comprising a personal electronic device in communication with the oven appliance sensor and the thermostat.

5. The temperature adjustment system of claim 1, wherein the thermostat is operable to adjust the temperature setting by a predetermined interval.

6. The temperature adjustment system of claim 1, wherein the thermostat is operable to adjust the temperature setting to a predetermined setpoint.

7. The temperature adjustment system of claim 1, wherein the operation of the oven appliance is an activation of the oven appliance.

8. The temperature adjustment system of claim 1, wherein the operation of the oven appliance is a temperature setting change.

9. The temperature adjustment system of claim 1, wherein the operation of the oven appliance is a cooking mode change.

10. The temperature adjustment system of claim 1, wherein the oven appliance sensor is operable to sense an operation of a chamber of the oven appliance.

11. The temperature adjustment system of claim 1, wherein the thermostat is operable to adjust a temperature setting in both an air conditioning mode and a heating mode.

12. The temperature adjustment system of claim 1, wherein a plurality of thermostats are in communication with the oven appliance sensor.

13. A method for adjusting a thermostat temperature setting, the method comprising:
sensing an operation of an oven appliance;
communicating the operation of the oven appliance to the thermostat; and
adjusting the thermostat temperature setting based on the sensed operation of the oven appliance.

14. The method of claim 13, wherein operation of the oven appliance is communicated directly to the thermostat.

15. The method of claim 13, wherein operation of the oven appliance is communicated indirectly to the thermostat.

16. The method of claim 13, wherein the thermostat temperature setting is adjusted by a predetermined interval.

17. The method of claim 13, wherein the thermostat temperature setting is adjusted to a predetermined setpoint.

18. The method of claim 13, wherein the operation of the oven appliance is one of an activation of the oven appliance, a temperature setting change, or a cooking mode change.

19. The method of claim 13, wherein the adjusting step occurs in both an air conditioning mode and a heating mode.

20. The method of claim 13, wherein the sensing step comprises sensing an operation of a chamber of the oven appliance.
